(19) United States
(12) Patent Application Publication
(10) Pub. No.: US 2009/0006960 A1
(43) Pub. Date: Jan. 1, 2009

(54) Multimedia system and information transmitting method

(75) Inventors: Wei-Hao Syu, Taipei (TW); Meng-Cheng Chen, Taipei (TW)

Correspondence Address: BACON & THOMAS, PLLC, 625 SLATERS LANE, FOURTH FLOOR, ALEXANDRIA, VA, 22314-1176, US

(73) Assignee: Arcadyan Technology Corporation, Hsinchu (TW)

(21) Appl. No.: 11/819,356

(22) Filed: Jun. 27, 2007

(51) Int. Cl. G06F 3/00

(52) U.S. Cl. 715/716

(57) ABSTRACT

A multimedia system for playing multimedia data is provided. The multimedia system comprises a media receiver and a remote control device. The media receiver comprises a multimedia processor and an interface server. The multimedia processor is for playing the multimedia data, accordingly generating first media information, and outputting the first media information. The interface server is for receiving and transforming the first media information into second media information, and outputting the second media information, wherein the second media information has a first markup language format. The remote control device receives and displays the second media information.

### BACKGROUND OF THE INVENTION

1. Field of the Invention

The invention relates in general to a multimedia system, and more particularly to a multimedia system which can provide the media information to be played and control information to a remote control device thereon.

2. Description of the Related Art

Along with increasing development of consuming electronic products, a family audio/video system has been invented to be capable of integrating, playing and managing various audio/video entertainments required in the family. For example, the family audio/video system includes a media receiver for receiving multimedia audio/video data and accordingly driving the corresponding user interface device, such as a display, speaker and personal computer, in order to perform the corresponding multimedia audio/video entertainment.

Conventionally, a remote control device is disposed for providing a simply remote operation interface for the user to control the media receiver. Owing the media receiver integrates a lot of audio/video entertainment functions, and a complicated selection-list process is needed in its operation. Therefore, when the user operates the media receiver, normally, he/she has to complete an accurate selection-list operation according to the media information responded by the media receiver and the control information. For example, when the user would like to play music via the media receiver, he/she can only find the desired music according to the control and media information, such as the position at which the music is stored, the name, player and specific collection of the music displayed by a display of the media receiver.

However, when the user is to control the media receiver via the remote control device, the control information in response to the user operation may become difficult to distinguish and the remote control operation of the media receiver may become very inconvenient due to too small size of the display disposed on the media receiver.

### SUMMARY OF THE INVENTION

The invention is directed to a multimedia system and data transmitting method, which can effectively resolve the issues of distinguishing difficulty of control information in response to the user operation and inconvenience of a remote control operation of the media receiver. Therefore, the control information can be effectively provided to the user and the remote control operation of the media receiver can have much more convenience.

According to a first aspect of the present invention, a multimedia system for playing multimedia data is provided. The multimedia system comprises a media receiver and a remote control device. The media receiver comprises a multimedia processor and an interface server. The multimedia processor is for playing the multimedia data, accordingly generating first media information, and outputting the first media information. The interface server is for receiving and transforming the first media information into second media information, and outputting the second media information, wherein the second media information has a first markup language format. The remote control device is for receiving and displaying the second media information.

According to a second aspect of the present invention, an information transmitting method of a multimedia system is provided for transmitting first media information to a remote control device of a media receiver. The first media information is related to multimedia data played by the media receiver. The information transmitting method comprises playing the multimedia data to generate the corresponding first media information; transforming the first media information into a second media information with a markup language format; outputting the second media information; and receiving and displaying the second media information on the remote control device.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a multimedia system according to a preferred embodiment of the invention.

FIG. 2 is a flow chart of an information transmitting method according to the preferred embodiment of the invention.

FIG. 3 is a partial flow chart of the information transmitting method according to the preferred embodiment of the invention.

### DETAILED DESCRIPTION OF THE INVENTION

The embodiment provides a multimedia system including a media receiver having an interface server, for providing the media information and operation information generated by the media receiver to the remote control device of the multimedia system to effectively display the corresponding information.

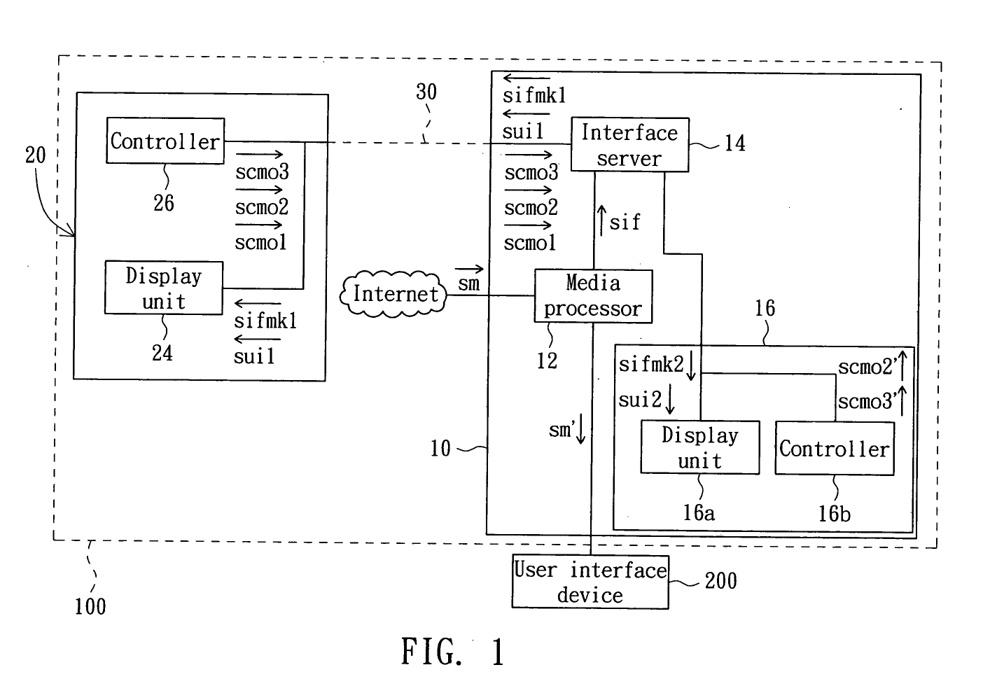

Referring to FIG. 1, a block diagram of a multimedia system according to a preferred embodiment of the invention is shown. A multimedia system 100 is for playing a piece of multimedia data sm and outputting the corresponding data via a user interface device 200. The multimedia data sm is, for example, an internet radio data transmitted through the internet. The multimedia system 100 includes a multimedia receiver 10 and a remote control device 20, which are connected via a wireless communication link 30.

The media receiver 10 includes a multimedia processor 12 and an interface server 14. The media processor 12 is for receiving and playing the multimedia data sm and generating multimedia data sm′ and media information sif according to the multimedia data sm. The multimedia data sm is accessed by the media receiver 12 via other communication link or electronic apparatus. For example, the multimedia data sm is internet broadcast data, and the media processor 12 is for respectively outputting the audio stream data and meta data in the internet broadcast data to be the multimedia data sm′ and media information sif.

The interface server 14 is for receiving and transforming the media information sif into media information sifmk1 and outputting the media information sifmk1 via the wireless communication link 30. The media information sifmk1 is, for example, information with a first markup language format. In the embodiment, the markup language is an extensible markup language (XML) and the first markup language format is a first data structure defined by XML for instance.

The remote control device 20 receives the media information sifmk1 via the wireless communication link 30. The remote control device 20 includes a display unit 24 for displaying information of the multimedia data sm according to the media information sifmk1. Therefore, the multimedia system 100 of the embodiment can effectively output media information related to the multimedia data sm played by the media receiver 10.

The remote control device 20 further includes a controller 26, such as a user-interface input device, for generating a command in response to an operation event triggered by the user and outputting the command via the wireless communication link 30. The operation event triggered by the user in the embodiment includes a selection-list event, control event and connection event and the controller 26 respectively generates the corresponding connection command scmo1, selection-list request command scmo2 and control command scmo3 in response to the connection, selection-list and control events.

When the user would like to connect the remote control device 20 with the media receiver 10, the connection event is triggered and the controller 26 generates and outputs the connection command scmo1 via the wireless communication link 30 in response to the connection event. The interface server 14 receives the connection command scmo1 and detects if the user triggers a pairing event on the media receiver 10. When the interface server 14 receives the connection command scmo1 and the pairing event is triggered, the interface server 14 sets up the wireless communication link 30.

When the wireless communication link 30 is set up, the user can control the operation of the media receiver 10 via a selection-list control interface provided by the interface server 14. When the user would like to control the media receiver 10 via the selection-list control interface, the selection-list event is triggered and the controller 26 generates and outputs the selection-list request command scom2 via the wireless communication link 30 in response to the selection-list event.

The interface server 14 is for receiving the selection-list request command scmo2 and generating corresponding update information (not shown in the figure) in response to the selection-list request command scmo2, and generating and outputting the selection-list response information sui1 via the wireless communication link 30 according to the update information. The selection-list response information sui1 has a first data structure defined by XML for instance. The remote control device 20 receives the selection-list response information sui1 via the wireless communication link 30 and displays the selection-list response information sui1 via the display unit 24.

The user can perform the selection-list operation via the controller 26, such as move up and down or enter and withdraw from different sub-selection lists. The controller 26 and interface server 14 respectively keep on updating the selection list request command scmo2 and selection-list response information sui1 through the above process.

When the user would like to play a multimedia file via a selection-list operation or control the media receiver 10 to perform the corresponding playing operation on the broadcast station the user is listening to, the control event is triggered and the controller 26 generates and outputs the command scmo3 via the wireless communication link 30 in response to the control event. The interface server 14 receives the command scmo3 and controls the multimedia processor 12 to play the corresponding multimedia data sm and generate the media information sif. The interface server 14 generates and outputs the media information sifmk1 to the remote control device 20 according to the media information sif to display the media information of the multimedia data sm.

The interface server 14 is for respectively transforming the media information sif and update information into the media information sifmk2 and selection-list information sui2 and outputting the information sifmk2 and sui2 via an inner communication link 40. The media information sifmk2 and selection-list information sui2 both have a second data structure defined by XML for instance. The media receiver 10 further includes a local interface unit 16 and the local interface unit 16 includes a display unit 16a for receiving and displaying the media information sifmk2 and selection-list information sui2 via the inner communication link 40 on the media receiver 10. For example, the display unit 16a is a display disposed on the media receiver 10 for displaying the relevant information of the multimedia data sm at the media receiver 10.

For example, the local interface unit 16 includes a controller 16b having similar functions to the controller 26 for generating a selection-list request command scom2′ and control command scom3′ in response to the operation event triggered by the user. The relevant operation can be reasoned by analog according to the above description of the controller 26.

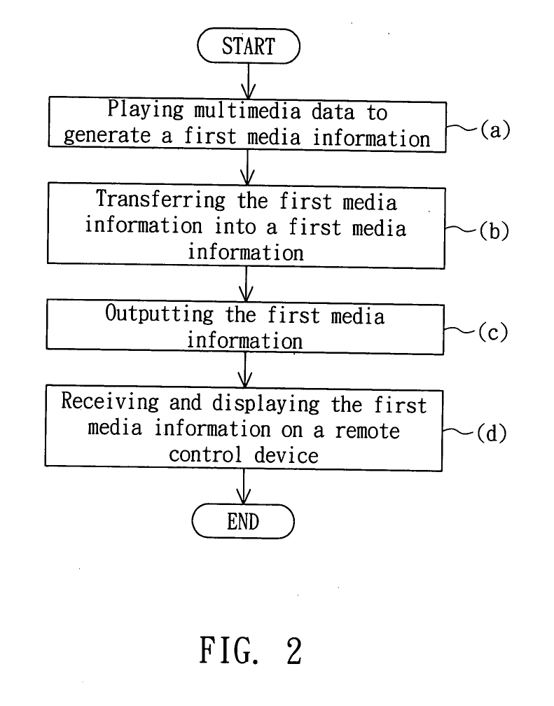

Referring to FIG. 2, a flow chart of an information transmitting method according to the preferred embodiment of the invention is shown. First, in step (a), the multimedia processor 12 plays the multimedia data sm and generates the corresponding media information sif. The multimedia processor 12 drives the user interface device 200 to output the multimedia data sm′. Following that, in step (b), the interface server 14 transforms the media information sif into the media information sifmk1, which is a first data structure defined by XML for instance.

Next, in step (c), the interface server 14 outputs the media information sifmk1 via the wireless communication link 30. Then, in step (d), the remote control device 20 receives and displays the media information sifmk1 on the control device 20 via the wireless communication link 30 in order to display the information of multimedia data sm on the remote control device 20.

The information transmitting method of the embodiment further includes a few transmission steps related to command setting among the wireless communication link 30, remote control device 20, interface server 14 and local interface unit 16, which are illustrated as below.

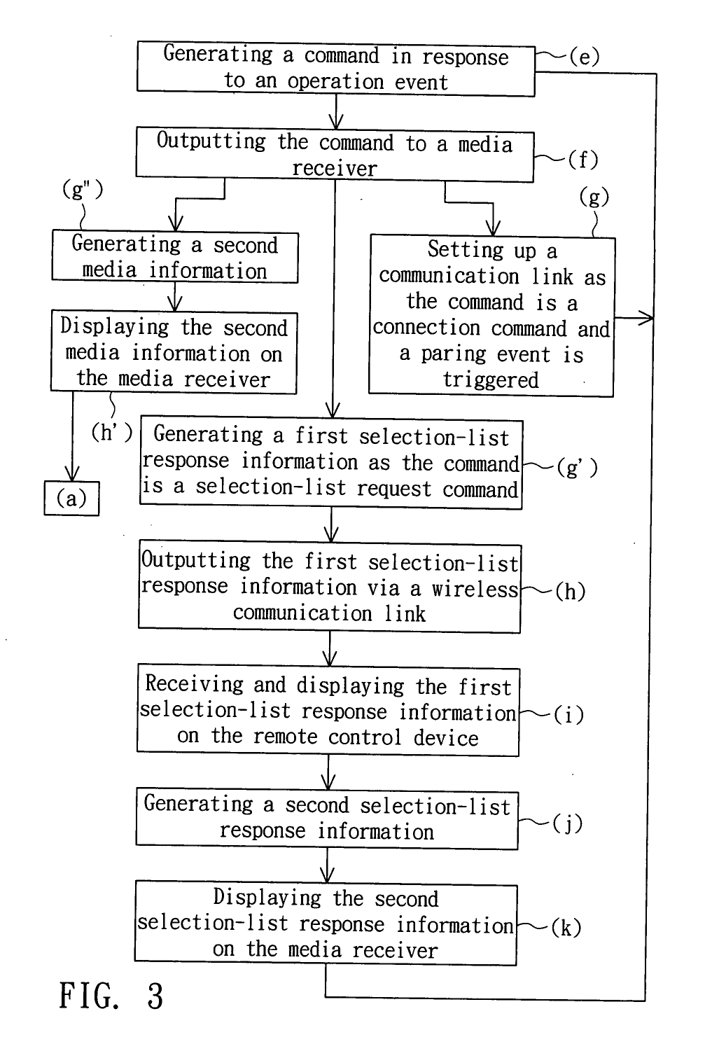

Referring to FIG. 3, a partial flow chart of the information transmitting method according to the preferred embodiment of the invention is shown. First, in step (e), the controller 26 generates a command in response to the selection-list event triggered by the user. Following that, in step (f), the remote control device 20 outputs the command to the media receiver 10 via the wireless communication link 30. When the command is a connection command scom1, the step (g) is performed. When the command received by the media receiver 10 is a connection command scom1 and a pairing event is triggered by the user on the media receiver 10, the interface server 14 sets up the wireless communication link 30. The step (e) is performed after the step (g).

After the step (f), when the command is the selection-list request command scom2, a step (g′) is performed, in which the interface server 14 generates the corresponding update information according to the selection-list request command scom2 and generates the selection-list response information sui1 according to the update information. Next, in step (h), the interface server 14 outputs the selection-list response information sui1 via the wireless communication link 30. Then, in step (i), the remote control device 20 receives the selection-list response information sui1 via the wireless communication link 30 and displays the selection-list response information sui1 via the display unit 24. After the step (i), the step (e) is performed.

Between the steps (i) and (e), the information transmitting method further includes a step (j) in which the interface server 14 generates the selection-list response information sui2 according to the update information and the selection-list response information sui2 is outputted to the local interface unit 16 via the inner communication link 40. Then, in step (k), the display unit 16a displays the selection-list response information sui2.

After the step (f), when the command is the control command scom3, the step (a) is performed, for controlling the multimedia processor 12 playing the multimedia data sm and generating the media information sif according to the control command scom3.

In the embodiment, between the steps (f) and (a), the method further includes a step (g″) in which the interface server 14 generates the media information sifmk2 according to the media information sif and the media information sifmk2 is outputted to the local interface unit 16 via the inner communication link 40. Next, in step (h′), the display unit 16a displays the media information sifmk2.

The first and second data structures defined by XML in the embodiment are respectively data structures defined according to the display performance of the display units 24 and 16a. For example, the display unit 16a is a simple single-color liquid crystal display and the first data structure defined by XML includes less media information for driving the display unit 16a to display a simple control frame.

The wireless communication link 30 of the embodiment, such as a wireless local area network (WLAN), is a communication link of the transport layer and network layer of a software layer stake respectively using transmission control protocol (TCP) and internet protocol (IP). The remote control device 20 of the embodiment is any electronic apparatus having wireless internet function, such as a mobile phone, personal digital assistant (PDA) or personal computer.

Although the multimedia system 100 is exemplified to include the media receiver 10 and remote control device 20 for illustration in the embodiment, the multimedia system 100 of the embodiment is not limited to having only one remote control device and can include two or more than two remote control devices. The remote control devices are all connected to the media receiver via the wireless communication link 30 and can be used to control the media receiver 20. Although the multimedia data sm is exemplified to be the internet radio data transmitted through the internet, the multimedia data sm is not limited thereto and can be any kind of multimedia data accessible to the media receiver 10.

The multimedia system of the embodiment includes a media receiver with an interface server for providing the media information and operation information generated by the media receiver to the remote control device of the multimedia system to effectively display the corresponding information. Therefore, the multimedia system and information transmitting method of the embodiment can effectively resolve the issues of distinguishing difficulty of the control information given by the conventional media receiver in response to the user operation and inconvenience of a remote control operation of the media receiver. That is, the control information can be effectively provided to the user and the remote control operation of the media receiver can have much more convenience.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multimedia system for playing multimedia data, comprising:
a media receiver, comprising:
a multimedia processor, for playing the multimedia data, accordingly generating a first media information, and outputting the first media information; and
an interface server, for receiving and transforming the first media information into a second media information, and outputting the second media information, wherein the second media information has a first markup language format; and
a remote control device, for receiving and displaying the second media information.

2. The multimedia system according to claim 1, wherein the remote control device further comprises:
a display unit, for receiving and displaying the second media information; and
a controller, for generating a command in response to an operation event and outputting the command.

3. The multimedia system according to claim 2, wherein the interface server is for receiving the command, and when the command is a connection command, the interface server sets up a wireless communication link as it receives the connection command and a pairing event is triggered.

4. The multimedia system according to claim 2, wherein the interface server is for receiving the command, and when the command is a selection-list request command, the interface server generates a first selection-list response information according to the selection-list request command and outputs the first selection-list response information via a wireless communication link, and the first selection-list response information has the first markup language format;
wherein the remote control device receives the first selection-list response information via the wireless communication link and displays the first selection-list response information via the display unit.

5. The multimedia system according to claim 4, wherein the interface server generates a second selection-list response information according to the selection-list request command and outputs the second selection-list response information via an inner communication link, and the second selection-list response information has a second markup language format;
wherein the media receiver further comprises a local interface unit for receiving and displaying the second selection-list response information via the inner communication link.

6. The multimedia system according to claim 2, wherein the interface server is for receiving the command, and when the command is a control command, the interface server controls the multimedia processor to play the multimedia data and generate the first media information according to the control command.

7. The multimedia system according to claim 6, wherein the interface server generates a third media information according to the control command and outputs the third media information via an inner communication link, and the third selection-list response information has a second markup language format;
wherein the media receiver further comprises a local interface unit for receiving and displaying the third media information via the inner communication link.

8. An information transmitting method of a multimedia system, for transmitting a first media information to a remote control device of a media receiver, the first media information being related to multimedia data played by the media receiver, the information transmitting method comprising:
(a) playing the multimedia data to generate the corresponding first media information;
(b) transforming the first media information into a second media information with a markup language format;
(c) outputting the second media information; and
(d) receiving and displaying the second media information on the remote control device.

9. The information transmitting method according to claim 8, further comprising:
(e) generating a command in response to a operation event triggered on the remote control device; and
(f) outputting the command to the media receiver.

10. The information transmitting method according to claim 9, wherein the step (f) further comprises:
(g) when the command received by the media receiver is a connection command and a pairing event is triggered, setting up a wireless communication link.

11. The information transmitting method according to claim 9, wherein after the step (f), the method further comprises:
(g′) when the command received by the media receiver is a selection-list request command, generating a first selection-list response information according to the selection-list request command;
(h) outputting the first selection-list response information via a wireless communication link; and
(i) receiving the first selection-list response information via the wireless communication link and displaying the first selection-list response information on the remote control device.

12. The information transmitting method according to claim 11, wherein after the step (i), the method further comprises:
(j) generating a second selection-list response information according to the selection-list request command, wherein the second selection-list response information has a second markup language format; and
(k) displaying the second selection-list response information on the media receiver.

13. The information transmitting method according to claim 9, wherein after the step (f), the method further comprises:
when the command received by the media receiver is a control command, executing the step (a).

14. The information transmitting method according to claim 13, wherein between the steps (f) and (a), the method further comprises:
(g″) generating a second media information, wherein the second media information has a second markup language format; and
(h′) displaying the second media information on the media receiver.
